(19) United States
(12) Patent Application Publication
(10) Pub. No.: US 2025/0155784 A1
(43) Pub. Date: May 15, 2025

(54) QUICK LOCKING DEVICE AND PHOTOGRAPHY KIT

(71) Applicant: Aespresso(Chongqing)Video Technology Co., Ltd., Chongqing (CN)

(72) Inventor: Kangping ZHOU, Chongqing (CN)

(73) Assignee: Aespresso(Chongqing)Video Technology Co., Ltd., Chongqing (CN)

(21) Appl. No.: 19/019,523

(22) Filed: Jan. 14, 2025

(30) Foreign Application Priority Data
Dec. 22, 2024 (CN) 2024118956032

(51) Int. Cl. G03B 17/56

(52) U.S. Cl. CPC G03B 17/561

(57) ABSTRACT

The present disclosure relates to the technical field of auxiliary photography equipment, and specifically to a quick locking device and a photography kit. The quick locking device comprises a base, a housing, a fixed chuck, a movable chuck, a driving body, a triggering member, and a locking head. The triggering member shifts the driving body to drive the movable chuck to get away from the fixed chuck when rotating, and then a camera quick release plate can be installed into a dovetail groove formed by the two chucks. After the installation is completed, the triggering member is automatically reset, and when rotating to be reset, the triggering member shifts the driving body to drive the movable chuck to quickly get close to the fixed chuck to clamp the camera quick release plate.

### CROSS-REFERENCE TO RELATED APPLICATIONS

The application claims priority to Chinese patent application No. 2024118956032, filed on Dec. 22, 2024, the entire contents of which are incorporated herein by reference.

### TECHNICAL FIELD

The present disclosure relates to the technical field of auxiliary photography equipment, and specifically to a quick locking device and a photography kit.

### BACKGROUND

Camera clamp holders are the most important and most commonly used equipment among photography equipment. When cameras are installed on stands for use, the clamp holders are basically required for clamping. Most of the existing camera clamp holders adopt knob push-type locking. Specifically, during locking, movable chucks are driven to move to open dovetail grooves by screwing knobs, and then the movable chucks are driven to reset and cooperate with fixed chucks to lock camera quick release plates by reversely screwing the knobs. According to the locking mode, repeated screwing of the knobs is required, resulting in cumbersome operation, and the movable chucks move slowly and are not quick to lock and unlock, resulting in relatively low efficiency.

### SUMMARY

In view of this, the objective of the present disclosure is to provide a quick locking device to solve the technical problems in the prior art that when knob push-type camera clamp holders are locked, repeated screwing of knobs is required, resulting in cumbersome operation, and that movable chucks move slowly and are not quick to lock and unlock, resulting in relatively low efficiency.

The present disclosure is achieved through the following technical solutions:
a quick locking device comprises a base and a housing fixedly arranged on the base, a top of the housing has a fixed chuck, a movable chuck is mounted in a snap-in manner on a side of the housing that is opposite to the fixed chuck, a side of the movable chuck that faces the fixed chuck is connected to a driving body, and a triggering member for shifting the driving body to move to drive the movable chuck to get away from or close to the fixed chuck for clamping is mounted on the base;
the triggering member is provided with a locking head thereon, and when the movable chuck moves to get close to the fixed chuck under the action of the triggering member, the locking head is quickly inserted into the driving body by the triggering member to abut against the driving body for locking.

Further, a clutch positioning column is integrally formed on the triggering member, a skewed groove A and a skewed groove B that is in communication with the skewed groove A are provided on the driving body, and the radius of a curve formed by connecting center points of both an inlet side of the skewed groove A and an end side of the skewed groove B in a groove body direction is gradually decreased;
the skewed groove A is located on a movement trajectory of the clutch positioning column, and the clutch positioning column pushes the driving body to move outward when the clutch positioning column enters the skewed groove B from the skewed groove A under the action of the triggering member.

Further, a convex block A and a convex block B are integrally formed at an interval on a side of the driving body that is away from the skewed groove A, and a locking groove that is in plug fit with the locking head is formed at an interval between the convex block A and the convex block B.

Further, a side of the base that faces inward is fixedly connected to a mounting column, an outer circumferential surface of the triggering member is fixedly provided with a support lug thereon, and a tension spring is mounted between the mounting column and the support lug.

Further, a limiting mechanism is mounted on the movable chuck, a limiting hole is provided on the housing, and when the movable chuck moves to cause the limiting mechanism to be aligned with the limiting hole, the limiting mechanism extends into the limiting hole to limit the movement of the movable chuck.

Further, a sliding groove is provided on an outer circumferential surface of the housing in an inwardly and outwardly through-going manner, a wrench is penetrated into the sliding groove, one end of the wrench is located outside the housing, and the other end of the wrench extends into the housing and is fixedly connected to the triggering member.

A photography kit comprises a plane thrust pan-tilt head, the plane thrust pan-tilt head comprises the quick locking device as described above, and the plane thrust pan-tilt head is connected to the underneath of the base in a threaded manner.

A photography kit comprises a camera conversion clamp holder, and the camera conversion clamp holder comprises the quick locking device as described above.

A photography kit comprises a quick release insert plate, and the quick release insert plate comprises the quick locking device as described above.

Beneficial effects of the present disclosure are as follows:
1. The triggering member can shift the driving body to drive the movable chuck to get away from the fixed chuck when rotating counterclockwise to quickly complete the unlocking of the clamp holder. Then, a camera quick release plate can be installed into a dovetail groove formed by the two chucks. After the installation is completed, the triggering member is shifted to be rotated and reset clockwise. When rotating, the triggering member shifts the driving body to drive the movable chuck to be quickly reset and to get close to the fixed chuck to clamp the camera quick release plate, and the locking head is inserted into the driving body to abut against the driving body for locking, thereby achieving the quick and stable locking of the camera quick release plate.

Compared with the prior art in which a knob pushes chucks to move for unlocking and clamping, the present disclosure provides the quick installation and locking of the camera quick release plate by only shifting the triggering member to rotate, the operation is more convenient, and meanwhile, the working efficiency and the usage experience are improved.
2. By arranging the limiting mechanism, the movable chuck can be limited from being moved and reset when the movable chuck gets away from the fixed chuck to reach a maximum stroke. When the camera quick release plate is installed into a dovetail groove formed by the two chucks, the limiting mechanism can be pressed downward to release the limitation. At this time, the triggering member is pulled to be quickly rotated and reset under an action force generated by the tension spring deformed to an original state, such that the movable chuck is driven to cooperate with the fixed chuck to clamp the camera quick release plate, and meanwhile the locking head is driven to be screwed into the locking groove to abut against the driving body for locking. Therefore, throughout the use process, the triggering member only needs to be manually rotated once to drive the movable chuck to get away from the fixed chuck, the operation is more convenient, and the response is faster.

### BRIEF DESCRIPTION OF DRAWINGS

FIG. 1 is an overall structural schematic diagram of a quick locking device of the present disclosure in a locked state.

FIG. 2 is an exploded view of the quick locking device of the present disclosure.

FIG. 3 is a structural schematic diagram of a triggering member and a driving body of the quick locking device of the present disclosure.

FIG. 4 is a positional schematic diagram of the triggering member of the quick locking device of the present disclosure in a locked state.

FIG. 5 is a positional schematic diagram of the triggering member of the quick locking device of the present disclosure in an open state.

FIG. 6 is an overall structural schematic diagram of the quick locking device of the present disclosure in an open state.

FIG. 7 is an overall structural schematic diagram of the quick locking device of the present disclosure in an open state in another direction.

FIG. 8 is a section view of a housing of the quick locking device of the present disclosure.

FIG. 9 is a structural schematic diagram of the housing of the quick locking device of the present disclosure.

FIG. 10 is a section view of a fixed chuck and a sleeve B of the quick locking device of the present disclosure.

FIG. 11 is a connection schematic diagram of a plane thrust pan-tilt head and a base of the present disclosure.

FIG. 12 is an overall structural schematic diagram of a camera conversion clamp holder of the present disclosure in a locked state.

FIG. 13 is an exploded view of the camera conversion clamp holder of the present disclosure.

FIG. 14 is a section view of a driving body and a movable chuck of the camera conversion clamp holder of the present disclosure.

FIG. 15 is an overall structural schematic diagram of the camera conversion clamp holder of the present disclosure in an open state.

FIG. 16 is an overall structural schematic diagram of a quick release insert plate of the present disclosure.

FIG. 17 is a sectional view of a housing, a driving body and a movable chuck of the quick release insert plate of the present disclosure.

In the figures: 1—base, 2—housing, 3—fixed chuck, 4—movable chuck, 5—driving body, 6—triggering member, 7—locking head, 8—skewed groove A, 9—skewed groove B, 10—clutch positioning column, 11—convex block A, 12—convex block B, 13—locking groove, 14—mounting column, 15—support lug, 16—tension spring, 17—socket, 18—mounting groove, 19—chute, 20—limiting hole, 21—sleeve A, 22—sleeve B, 23—spring, 24—insert block A, 25—insert block B, 26—sliding groove, 27—wrench, 28—plane thrust pan-tilt head, 29—camera conversion clamp holder, 30—quick release insert plate, 31—limiting mechanism.

### DETAILED DESCRIPTION OF THE EMBODIMENTS

Typical embodiments embodying the features and advantages of the present disclosure will be described in detail in the following description. It should be understood that the present disclosure can have various changes of different embodiments without departing from the scope of the present disclosure, and the description and figures are essentially used for illustration, not for limiting the present disclosure.

In the description of the present application, orientation or position relationships indicated by terms, such as “up” and “down”, are orientation or position relationships shown based on the accompanying drawings, only to facilitate the description of the present disclosure and simplify the description, rather than to indicate or imply that structures referred to must have specific orientations or be constructed and operated in the specific orientations, and therefore shall not be understood as limitations to the present application.

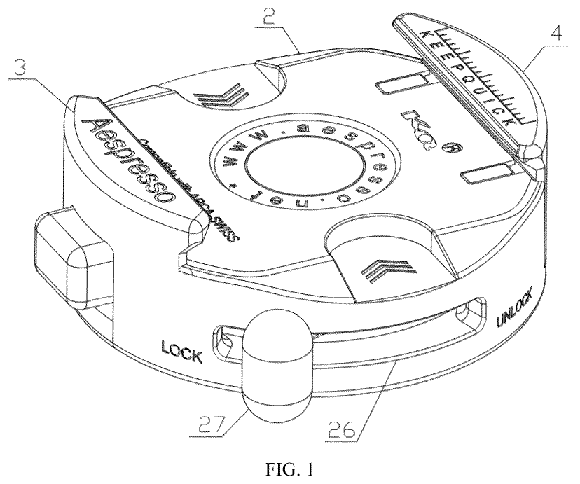

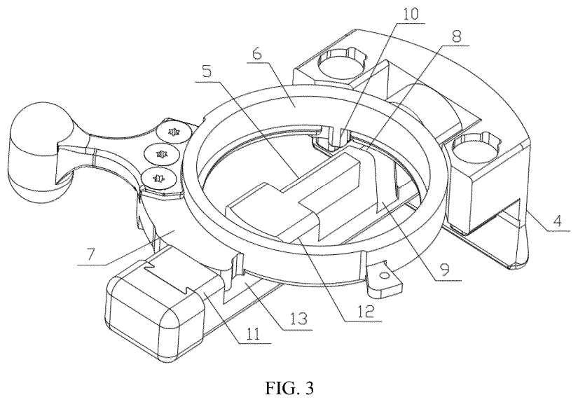

Referring to FIGS. 1-4, the present disclosure provides a technical solution: a quick locking device, comprising a base 1 and a housing 2 fixed above the base 1 through screws. The base 1 is a threaded quick release base. In the present embodiment, the base 1 and the housing 2 are generally circular, and certainly may also be designed into any shape as needed, for example, square or long strip-shaped. A top of the housing 2 has a fixed chuck 3, and a movable chuck 4 is mounted in a snap-in manner on a side of the housing 2 that is opposite to the fixed chuck 3.

A driving body 5 is integrally formed on a side of the movable chuck 4 that faces the housing 2. In the present application document, the driving body 5 is long strip-shaped and is connected to the movable chuck 4 to form a T-shaped structure. The driving body 5 may also be in other shapes, for example, an arc-shaped or annular structure, etc.

A triggering member 6 is mounted at the center of the base 1 through a bearing, and the triggering member 6 is located below the driving body 5. In the present application document, the triggering member 6 is in a circular island shape. The triggering member 6 may also be in other shapes, for example, an arc-shaped structure capable of rotating around the center of the base 1, etc.

A clutch positioning column 10 is integrally formed on a top of the triggering member 6, a skewed groove A8 and a skewed groove B9 are provided on a bottom surface of one end of the driving body 5 that is close to the movable chuck 4, the skewed groove A8 and the skewed groove B9 are communicated on the bottom surface of the driving body 5 to form a sickle-like groove body, the radius of a curve formed by connecting center points of both an inlet side of the skewed groove A8 and an end side of the skewed groove B9 in a groove body direction is gradually decreased, and a movement trajectory of the clutch positioning column 10 is always opposite to a groove wall of the skewed groove B9.

When the triggering member 6 rotates to drive the clutch positioning column 10 to enter the skewed groove B9 from the skewed groove A8, because the movement trajectory of the clutch positioning column 10 is always opposite to the groove wall of the skewed groove B9, the end side of the skewed groove B9 is biased toward a rotation center direction of the triggering member 6, and then the clutch positioning column 10 can push the driving body 5 to move outward when moving along the skewed groove B9, thereby driving the movable chuck 4 to get away from the fixed chuck 3. On the contrary, the triggering member 6 can drive the movable chuck 4 to get close to the fixed chuck 3 when rotating reversely. Two ends of the skewed groove A8 and the skewed groove B9 have a height difference on a vertical plane, and the height difference determines a displacement distance of the driving body 5.

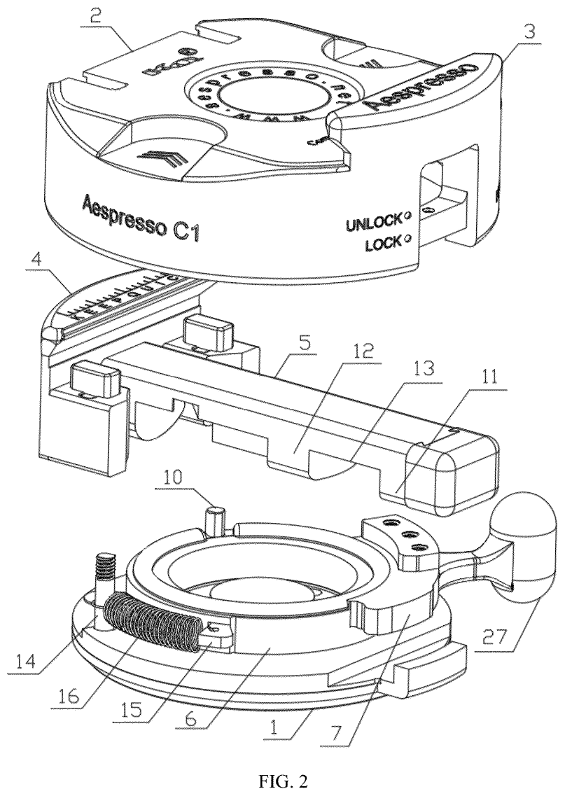

Referring to FIGS. 2-5, a convex block A11 and a convex block B12 are integrally formed at an interval on a bottom surface of one end of the driving body 5 that is away from the skewed groove A8, and a locking groove 13 that is in plug fit with a locking head 7 is formed at an interval between the convex block A11 and the convex block B12.

An outer edge of the triggering member 6 is provided with the locking head 7, and the locking head 7 is in a curved blade shape. In a top view state, when the triggering member 6 rotates counterclockwise or clockwise under the action of an external force, on the one hand, the driving body 5 is shifted to drive the movable chuck 4 to get away from the fixed chuck 3 through the cooperation between the clutch positioning column 10 and the skewed grooves, thereby opening a dovetail groove of a clamp holder or driving the movable chuck 4 to get close to the fixed chuck 3 to clamp a camera quick release plate.

On the other hand, when the triggering member 6 rotates counterclockwise and drives the locking head 7 to get away from a locking groove 13, the driving body 5 can move at this time. When the trigger member 6 rotates clockwise and drives the locking head 7 to be inserted into the locking groove 13, the locking head 7 abuts against the driving body 5 and provides an outward force to lock the driving body 5, thereby achieving the locking of the camera quick release plate.

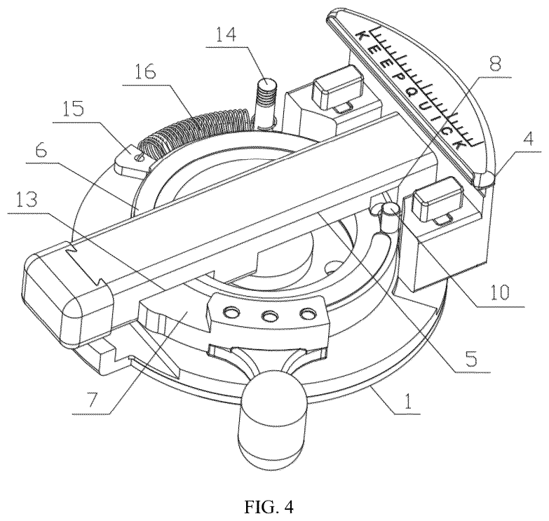

Referring to FIGS. 4-6, a side of the base 1 that faces inward is fixedly connected to a mounting column 14, an outer circumferential surface of the triggering member 6 is fixedly provided with a support lug 15 thereon, and a tension spring 16 is mounted between the mounting column 14 and the support lug 15.

A limiting mechanism 31 is mounted on the movable chuck 4, and a limiting hole 20 is provided on the housing 2. When the driving body 5 moves outward to reach a maximum stroke under the action of the triggering member 6, the tension spring 16 is stretched, and the limiting mechanism 31 extends into the limiting hole 20 to limit the movement and resetting of the movable chuck 4. When the camera quick release plate is installed into the clamp holder, the limiting mechanism 31 can be pressed downward to release the limitation of the limiting mechanism 31. At this time, the tension spring 16 deforms back to an original shape and shifts the triggering member 6 to rotate clockwise. When the triggering member 6 rotates clockwise, on the one hand, the clutch positioning column 10 shifts the driving body 5 to drive the movable chuck 4 to get close to the fixed chuck 3 for clamping.

On the other hand, the triggering member 6 rotates and simultaneously drives the locking head 7 to be inserted into the locking groove 13 to abut against the driving body 5, thereby completing the fixation of the camera quick release plate.

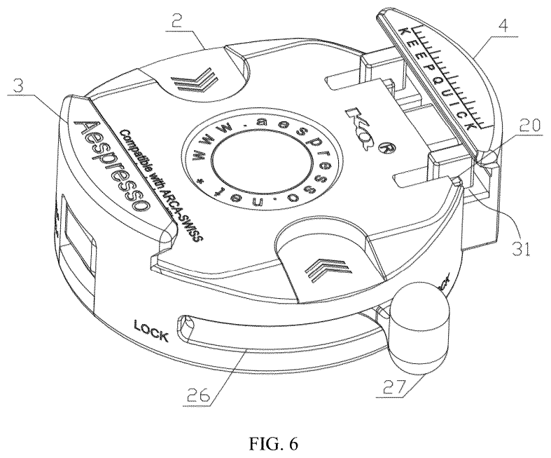

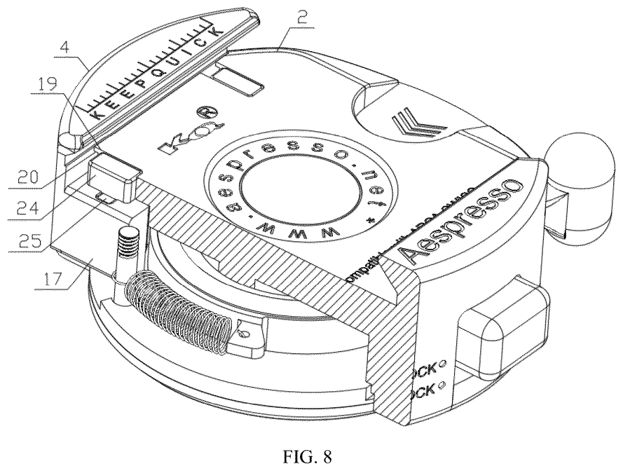

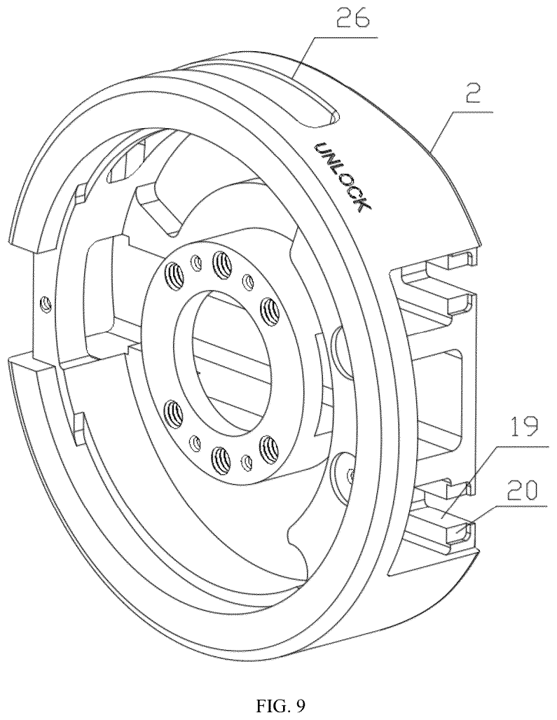

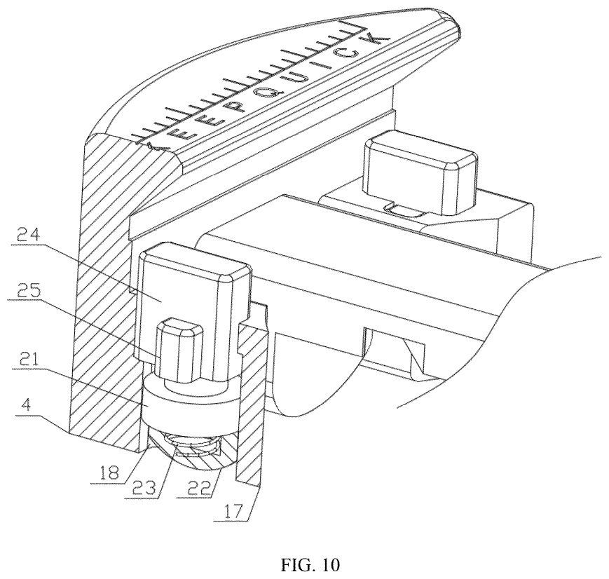

Referring to FIG. 6, FIG. 8, FIG. 9 and FIG. 10, a socket 17 is integrally formed on a side of the movable chuck 4 that faces the housing 2, a mounting groove 18 is provided on the socket 17 in an upwardly and downwardly through-going manner, and the limiting mechanism 31 comprises an elastic stopping member that is mounted in the mounting groove 18.

A chute 19 that is in communication with the limiting hole 20 is provided on the housing 2 in a movement direction of the movable chuck 4. When the movable chuck 4 moves to cause the elastic stopping member to be aligned with the limiting hole 20, the elastic stopping member pops up to limit the movement and resetting of the movable chuck 4.

Referring to FIG. 8 and FIG. 10, the elastic stopping member comprises a sleeve A21 and a sleeve B22 that are arranged up and down, and a spring 23 is jointly mounted in the sleeve A21 and the sleeve B22.

A top of the sleeve B22 is fixedly provided with a positioning pin. In the present embodiment, the positioning pin is cross-shaped, the positioning pin comprises an insert block A24 that is in sliding fit with the chute 19, an insert block B25 is integrally formed in a side portion of the insert block A24, and a top surface of the insert block B25 is lower than a top surface of the insert block A24 and abuts against the housing 2 under the action of the spring 23.

When the driving body 5 pushes the movable chuck 4 to get away from the fixed chuck 3 under the action of the triggering member 6, the insert block A24 slides along the chute 19. When the movable chuck 4 moves to reach a farthest stroke, the insert block B25 is aligned with the limiting hole 20 at this time and pushes the positioning pin to move upward under a deformation action force of the spring 23, such that the insert block B25 enters the limiting hole 20. At this time, the insert block B25 abuts against the housing 2 under a horizontal resetting action force generated by deformation of the tension spring 16 to limit the movement of the movable chuck 4, thereby facilitating the one-handed operation and installation of the camera quick release plate.

Referring to FIG. 1, FIG. 2, FIG. 6 and FIG. 9, a sliding groove 26 is provided on an outer circumferential surface of the housing 2 in an inwardly and outwardly through-going manner, a wrench 27 is penetrated into the sliding groove 26, one end of the wrench 27 is located outside the housing 2, and the other end of the wrench extends into the housing 2 and is fixedly connected to the triggering member 6. Specifically, a rotation angle of the triggering member 6 can be limited through the sliding groove 26. Maximum strokes at two ends of the sliding groove 26 correspond to locked and open states of the movable chuck 4, respectively. The wrench 27 is conducive to shifting the triggering member 6 to rotate.

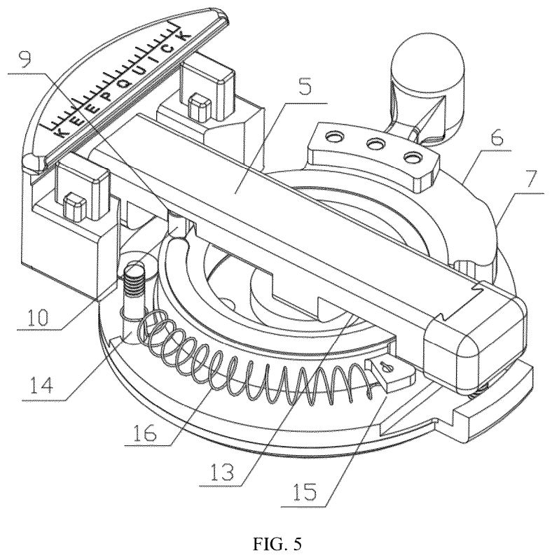

Working principle of the present disclosure: An initial state of the triggering member 6 of the present disclosure is shown in FIG. 4 (locked state). When the triggering member 6 is shifted by the wrench 27 to rotate counterclockwise, the triggering member 6 stretches the tension spring 16 when rotating counterclockwise. Moreover, when the triggering member 6 rotates, on the one hand, the locking head 7 is driven to rotate synchronously, such that the locking head 7 moves out of the locking groove 13 to release the locking of the driving body 5. On the other hand, the clutch positioning column 10 is synchronously driven to move from the skewed groove A8 to the skewed groove B9 to shift the driving body 5 to move outward, thereby driving the movable chuck 4 to get away from the fixed chuck 3, as shown in FIG. 5.

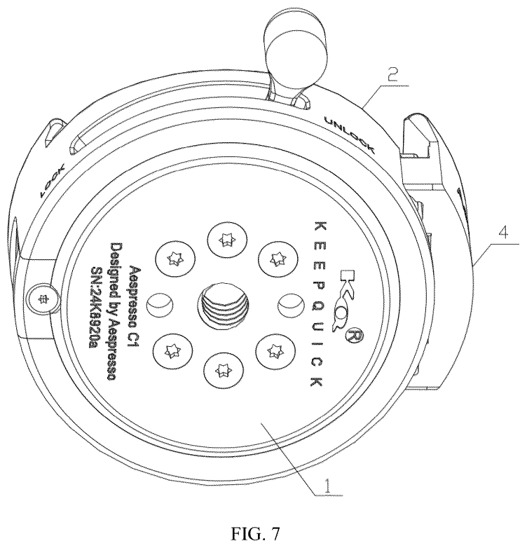

When the movable chuck 4 gets away from the fixed chuck 3, the insert block A24 slides along the chute 19. When the wrench 27 rotates counterclockwise to reach a farthest stroke, as shown in FIG. 6 and FIG. 7, the movable chuck 4 moves at this time to cause the insert block B25 to be aligned with the limiting hole 20, and the positioning pin is pushed to move upward under a deformation action force of the spring 23, such that the insert block B25 enters the limiting hole 20. The insert block B25 abuts against the housing 2 under a horizontal resetting action force generated by deformation of the tension spring 16 to limit the movement and resetting of the movable chuck 4, and at this time, the camera quick release plate can be installed into a dovetail groove formed by the two chucks.

The camera quick release plate presses downward the insert block A24 that is located on two sides of the movable chuck 4 in an installation process, such that the insert block B25 is downwardly detached from the limiting hole 20. At this time, the triggering member 6 is pulled and quickly rotated clockwise to reset under the action generated by the tension spring 16 deformed back to an original state. When the triggering member 6 rotates clockwise, on the one hand, the clutch positioning column 10 moves from the skewed groove B9 to the skewed groove A8 to shift the driving body 5 to move inward, thereby driving the movable chuck 4 to be quickly reset and to get close to the fixed chuck 3 to clamp the camera quick release plate.

On the other hand, the locking head 7 is driven by rapid rotation of the triggering member 6 and is screwed into the locking groove 13 to abut against the driving body 5, thereby providing an outward force to lock the driving body 5, ensuring the stability of installation of the camera quick release plate, and achieving the quick installation and locking of the camera quick release plate.

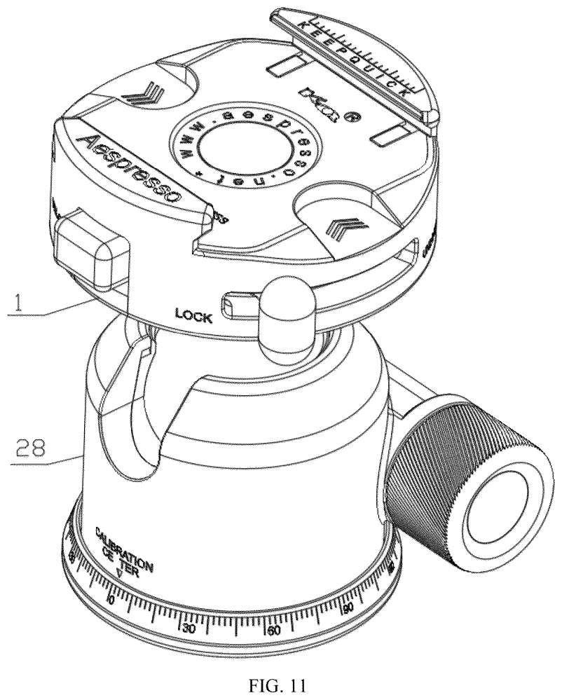

Referring to FIG. 11, the present disclosure further provides a technical solution: a photography kit, comprising a plane thrust pan-tilt head 28. The plane thrust pan-tilt head 28 comprises the quick locking device as described above. The plane thrust pan-tilt head 28 is connected to the underneath of the base 1 in a threaded manner. By employing the pan-tilt head of a clamp holder of the present application document, the camera quick release plate can be quickly installed onto the clamp holder, such that photography equipment can be quickly installed, the operation is more convenient, and the working efficiency and the usage experience are improved.

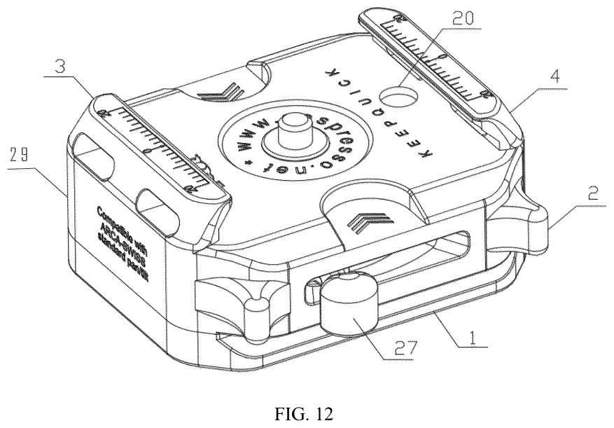

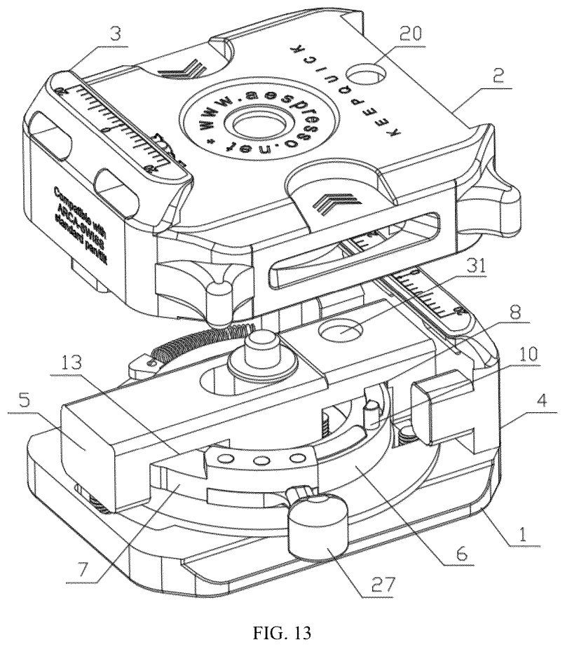

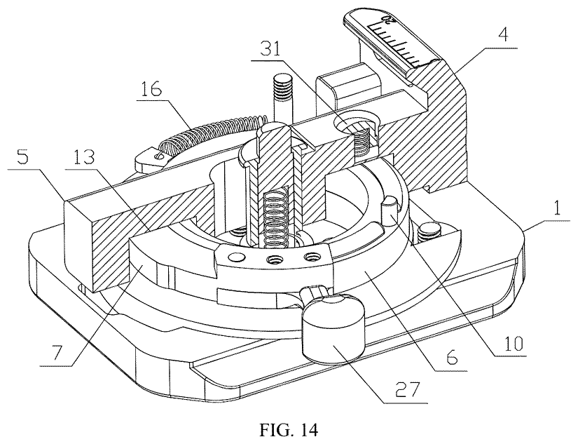

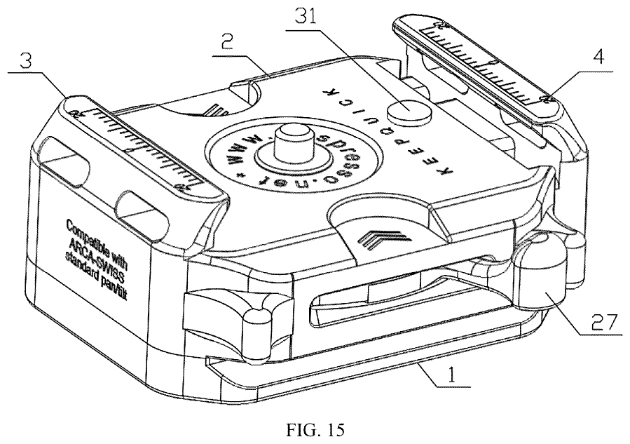

Referring to FIGS. 12-15, the present disclosure further provides a technical solution: a photography kit, comprising a camera conversion clamp holder 29 that is generally square-shaped. A base 1 of the camera conversion clamp holder 29 employs a dovetail groove quick release base. The camera conversion clamp holder 29 comprises the quick locking device as described above, and unlike the quick locking device, the limiting mechanism 31 is mounted onto the driving body 5, and the limiting mechanism 31 employs the cooperation between a spring and a cylindrical or otherwise shaped pin. When the driving body 5 is shifted outward by the triggering member 6 to reach a maximum stroke (at which point, the movable chuck 4 gets far away from the fixed chuck 3 to open a dovetail groove of the clamp holder), the pin in the limiting mechanism 31 moves upward under an action force generated by deformation of the spring and is then inserted into the limiting hole 20 on the housing 2 to limit the movement of the driving body 5. When the camera quick release plate is installed into the dovetail groove, the pin can be pressed downward, and at this time, the tension spring 16 deforms and pulls the triggering member 6 to rotate and shift the driving body 5 to quickly move and reset the driving body, such that the movable chuck 4 gets close to the fixed chuck 3 to quickly clamp the camera quick release plate for locking. The working process is the same as that of the quick locking device, which will not be repeatedly described in detail herein. The limiting mechanism 31 can be arranged on the driving body 5 or at other positions according to functional requirements, thereby achieving the purposes to quickly install photography equipment onto the camera conversion clamp holder 29 and improve the working efficiency and the usage experience.

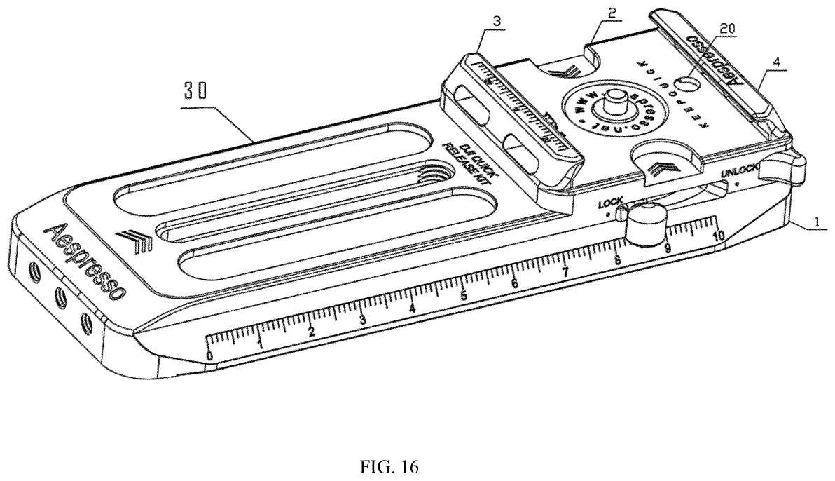

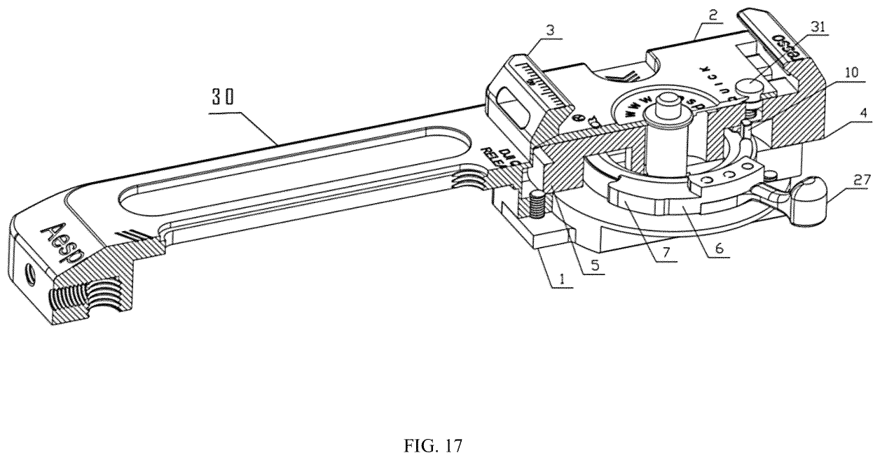

Referring to FIG. 16 and FIG. 17, the present disclosure further provides a technical solution: a photography kit, comprising a quick release insert plate 30. The quick release insert plate 30 comprises the quick locking device as described above. A housing 2 of the quick release insert plate 30 is generally rectangular, and the quick locking device mounted at an end portion thereof is the same as the quick locking device used in the camera conversion clamp holder 29 to achieve the purposes to quickly install photography equipment and improve the working efficiency and the usage experience.

Finally, it should be noted that the above-mentioned embodiments are only preferred embodiments of the present disclosure and cannot be used to limit the scope of protection of the present disclosure. Any non-substantial changes and substitutions that are made by those skilled in the art on the basis of the present disclosure shall fall within the scope of protection as claimed by the present disclosure.

What is claimed is:

1. A quick locking device, comprising a base and a housing fixedly arranged on the base, a top of the housing having a fixed chuck, and a movable chuck being mounted in a snap-in manner on a side of the housing that is opposite to the fixed chuck, wherein: a side of the movable chuck that faces the fixed chuck is connected to a driving body, and a triggering member for shifting the driving body to move to drive the movable chuck to get away from or close to the fixed chuck for clamping is mounted on the base;
the triggering member is provided with a locking head thereon, and when the movable chuck moves to get close to the fixed chuck under the action of the triggering member, the locking head is quickly inserted into the driving body by the triggering member to abut against the driving body for locking.

2. The quick locking device according to claim 1, wherein: a clutch positioning column is integrally formed on the triggering member, a skewed groove A and a skewed groove B that is in communication with the skewed groove A are provided on the driving body, and the radius of a curve formed by connecting center points of both an inlet side of the skewed groove A and an end side of the skewed groove B in a groove body direction is gradually decreased;
the skewed groove A is located on a movement trajectory of the clutch positioning column, and the clutch positioning column pushes the driving body to move outward when the clutch positioning column enters the skewed groove B from the skewed groove A under the action of the triggering member.

3. The quick locking device according to claim 2, wherein: a convex block A and a convex block B are integrally formed at an interval on a side of the driving body that is away from the skewed groove A, and a locking groove that is in plug fit with the locking head is formed at an interval between the convex block A and the convex block B.

4. The quick locking device according to claim 1, wherein: a side of the base that faces inward is fixedly connected to a mounting column, an outer circumferential surface of the triggering member is fixedly provided with a support lug thereon, and a tension spring is mounted between the mounting column and the support lug.

5. The quick locking device according to claim 1, wherein: a limiting mechanism is mounted on the movable chuck, a limiting hole is provided on the housing, and when the movable chuck moves to cause the limiting mechanism to be aligned with the limiting hole, the limiting mechanism extends into the limiting hole to limit the movement of the movable chuck.

6. The quick locking device according to claim 1, wherein: a sliding groove is provided on an outer circumferential surface of the housing in an inwardly and outwardly through-going manner, a wrench is penetrated into the sliding groove, one end of the wrench is located outside the housing, and the other end of the wrench extends into the housing and is fixedly connected to the triggering member.

7. A photography kit, comprising a plane thrust pan-tilt head, wherein: the plane thrust pan-tilt head comprises the quick locking device according to claim 1, and the plane thrust pan-tilt head is connected to the underneath of the base of the quick locking device in a threaded manner.

8. A photography kit, comprising a plane thrust pan-tilt head, wherein: the plane thrust pan-tilt head comprises the quick locking device according to claim 2, and the plane thrust pan-tilt head is connected to the underneath of the base of the quick locking device in a threaded manner.

9. A photography kit, comprising a plane thrust pan-tilt head, wherein: the plane thrust pan-tilt head comprises the quick locking device according to claim 3, and the plane thrust pan-tilt head is connected to the underneath of the base of the quick locking device in a threaded manner.

10. A photography kit, comprising a plane thrust pan-tilt head, wherein: the plane thrust pan-tilt head comprises the quick locking device according to claim 4, and the plane thrust pan-tilt head is connected to the underneath of the base of the quick locking device in a threaded manner.

11. A photography kit, comprising a plane thrust pan-tilt head, wherein: the plane thrust pan-tilt head comprises the quick locking device according to claim 5, and the plane thrust pan-tilt head is connected to the underneath of the base of the quick locking device in a threaded manner.

12. A photography kit, comprising a plane thrust pan-tilt head, wherein: the plane thrust pan-tilt head comprises the quick locking device according to claim 6, and the plane thrust pan-tilt head is connected to the underneath of the base of the quick locking device in a threaded manner.

13. A photography kit, comprising one of a camera conversion clamp holder and a quick release insert plate, wherein: the one of the camera conversion clamp holder and the quick release insert plate comprises the quick locking device according to claim 1.

14. A photography kit, comprising one of a camera conversion clamp holder and a quick release insert plate, wherein: the one of the camera conversion clamp holder and the quick release insert plate comprises the quick locking device according to claim 2.

15. A photography kit, comprising one of a camera conversion clamp holder and a quick release insert plate, wherein: the one of the camera conversion clamp holder and the quick release insert plate comprises the quick locking device according to claim 3.

16. A photography kit, comprising one of a camera conversion clamp holder and a quick release insert plate, wherein: the one of the camera conversion clamp holder and the quick release insert plate comprises the quick locking device according to claim 4.

17. A photography kit, comprising one of a camera conversion clamp holder and a quick release insert plate, wherein: the one of the camera conversion clamp holder and the quick release insert plate comprises the quick locking device according to claim 5.

18. A photography kit, comprising one of a camera conversion clamp holder and a quick release insert plate, wherein: the one of the camera conversion clamp holder and the quick release insert plate comprises the quick locking device according to claim 6.
